(19) United States
(12) Patent Application Publication
(10) Pub. No.: US 2026/0198536 A1
(43) Pub. Date: Jul. 16, 2026

(54) REFRIGERATOR, AND METHOD FOR AGING FOOD USING SAME

(71) Applicant: SAMSUNG ELECTRONICS CO., LTD., Suwon-si (KR)

(72) Inventors: Jungeun SEO, Suwon-si (KR); Deulre MIN, Suwon-si (KR); Chanbin PARK, Suwon-si (KR); Seokjun SON, Suwon-si (KR); Jinhong YU, Suwon-si (KR)

(73) Assignee: SAMSUNG ELECTRONICS CO., LTD., Suwon-si (KR)

(21) Appl. No.: 19/566,721

(22) Filed: Mar. 13, 2026

Related U.S. Application Data
(63) Continuation of application No. PCT/KR2024/012089, filed on Aug. 14, 2024.

(30) Foreign Application Priority Data
Oct. 12, 2023 (KR) 10-2023-0136296
Dec. 15, 2023 (KR) 10-2023-0183711

(51) Int. Cl. A23L 5/30; A21C 13/00; A23L 19/20; F25D 29/00; F25D 31/00

(52) U.S. Cl. CPC A23L 5/30; A21C 13/00; A23L 19/20; F25D 29/00; F25D 31/005; F25D 2400/02; F25D 2400/361; F25D 2600/04

(57) ABSTRACT

A refrigerator includes an aging chamber configured to store an object to be aged, a cooling portion configured to reduce a temperature in the aging chamber, a heating portion configured to increase the temperature in the aging chamber, a controller configured to control an aging temperature of the aging chamber by controlling at least one of the cooling portion and the heating portion to allow an aging process to be performed on the stored object for a preset aging time, and a storage configured to store user feedback information on at least one of an aging degree of the object for which the aging process is completed and food manufactured using the object. The controller is configured to control at least one of the aging temperature and the aging time based on the user feedback.

### CROSS REFERENCE TO THE RELATED APPLICATION

This application is a continuation application, filed under 35 U.S.C. § 111(a), of International Application PCT/KR2024/012089 filed Aug. 14, 2024, and is based on and claims priority under 35 U.S.C. § 119 to Korean Patent Applications No. 10-2023-0136296, filed on Oct. 12, 2023 and Korean Patent Applications No. 10-2023-0183711, filed on December 15, 2023 in the Korean Intellectual Property Office, the disclosures of which are incorporated by reference herein in their entireties.

### TECHNICAL FIELD

The disclosure relates to a refrigerator and a method for aging food using the refrigerator.

### BACKGROUND ART

A refrigerator includes a storage compartment for storing food and a cold air supply device for supplying cold air to the storage compartment. The storage compartment may include a refrigerating compartment maintained at approximately −2 to 15 degrees Celsius to store food in a refrigerated manner, and a freezing compartment maintained at approximately 0 to −30 degrees Celsius to store food in a frozen manner.

The refrigerator may include an aging chamber capable of independently controlling an internal temperature. The aging chamber may age food such as kimchi, dough, meat, wine, and the like. For food stored in the aging chamber, the lower the aging temperature, the slower the aging speed, and the higher the aging temperature, the faster the aging speed.

For example, there are various types of kimchi, such as baechu-kimchi, dongchimi, kkakdugi, gat-kimchi, yeolmu-kimchi, mugeun-ji, and the like. Depending on the type of kimchi, the kimchi may already be in a state where aging has progressed to some extent before being stored in an aging chamber.

Accordingly, in a case where an aging process is performed without considering the aging state of the kimchi stored in the aging chamber, the final aging quality of the kimchi may vary.

The dough stored in the aging chamber may be used to prepare various foods, such as white bread, pizza, muffins, and the like, after the aging process. Depending on the intended use, the dough may contain different amounts of flour, salt, water, sugar, fat, yeast, and the like.

Before being stored in the aging chamber, the dough may already be in a state where aging has progressed to some extent according to the intended use described above. The aging state of the dough may be identified by its size.

Accordingly, in a case where an aging process is performed without considering the aging state of the dough stored in the aging chamber, the final aging quality of the dough may vary.

In addition, to prevent cases where the aging degree of the food after completion of the aging process does not reach a user-desired level, or where a dish prepared using the food is not satisfactory, user feedback is required to be reflected in the subsequent aging process to improve user satisfaction.

### DISCLOSURE

### Technical Solution

The disclosure provides a refrigerator that may effectively age an object stored in an aging chamber, and a method for aging food using the refrigerator.

According to an aspect of the disclosure, a refrigerator may include: an aging chamber configured to store an object to be aged; a cooling portion configured to reduce a temperature in the aging chamber; a heating portion configured to increase the temperature in the aging chamber; a controller configured to control an aging temperature of the aging chamber by controlling at least one of the cooling portion and the heating portion to allow an aging process to be performed on the stored object for a preset aging time; and a storage configured to store user feedback information on at least one of an aging degree of the object for which the aging process is completed and food manufactured using the object, wherein the controller may be configured to control at least one of an aging temperature and an aging time based on the user feedback information.

The refrigerator may further include a scan portion configured to, based on a packaged product being stored in the aging chamber, scan at least one of a product name, a manufacturing date, a capacity, and a barcode of the packaged product.

The refrigerator may further include a user interface including a display, the user interface configured to, based on the object being stored in the aging chamber, display a menu on the display to allow a selection of at least one of a type, a manufacturing date, a target aging degree, a purpose of aging, and a capacity of the object.

The refrigerator may further include: a sensor configured to measure an aging degree of kimchi, based on the kimchi being stored in the aging chamber; the storage may be further configured to store at least one of an aging state, a type, and a capacity of the kimchi, the aging state being measured by the sensor before the aging process is performed, wherein the controller may be further configured to set at least one of an aging temperature and an aging time to reach a preset target aging degree of the kimchi based on the at least one of the aging state, the type, and the capacity of the kimchi.

The controller may be configured to: measure the aging degree of the kimchi by the sensor at a preset interval during the aging process of the kimchi stored in the aging chamber; determine whether the target aging degree is reachable within the aging time based on the measured aging degree of the kimchi; and adjust the aging temperature of the kimchi to reach the target aging degree within the aging time based on a result of determination.

The controller may be further configured to: transmit, to a user terminal, a message inquiring about whether to adjust the aging temperature of the kimchi based on the result of determination; and adjust the aging temperature of the kimchi based on a response to the message received from the user terminal.

The controller may be further configured to operate the aging chamber in a storage mode at a set temperature, in response to the aging state of the kimchi exceeding the target aging degree of the kimchi.

The sensor may configured to measure a pH value indicating the aging degree of the kimchi.

The refrigerator may further include: a sensor configured to measure an aging degree of dough, based on the dough being stored in the aging chamber, wherein the controller may be further configured to set at least one of an aging temperature and an aging time to reach a preset target aging degree of the dough based on at least one of an aging state, a type, and a capacity of the dough, the aging state being measured by the sensor before the aging process is performed.

The sensor may include a camera configured to detect a size of the dough to measure the aging degree of the dough, and the controller may be further configured to: measure a size of the dough by the sensor at a preset interval during the aging process of the dough stored in the aging chamber; determine whether the target aging degree is reachable within the aging time based on the measured size of the dough; and adjust the aging temperature of the dough to reach the target aging degree within the aging time based on a result of determination.

The heating portion may include: a heater case configured to support a lower part of the aging chamber; and a heater accommodated in the heater case, and wherein the heater case may include a lower frame and an upper frame coupled to an upper part of the lower frame, the heater may be attached to an inner top surface of the upper frame, and the lower frame may include a protrusion configured to support the heater to allow the heater to be in close contact with the upper frame.

The refrigerator may further comprise user interface including a display, and the user feedback information may be received through the user interface and stored in the storage.

According to another aspect of the disclosure, a method for aging food in a refrigerator having an aging chamber, a controller configured to control an aging temperature in the aging chamber and a storage, may include: performing, by the refrigerator, the aging process on an object stored in an aging chamber based on an aging temperature and an aging time; receiving, by the controller, user feedback information on at least one of an aging degree of the object for which the aging process is completed or food manufactured using the object; and controlling, by the controller, at least one of an aging temperature and an aging time based on the received user feedback information.

The method may further include transmitting an aging completion message to a user terminal, based on completion of the aging process.

The method may further include: measuring an aging state of the object stored in the aging chamber before the aging process is performed; and setting at least one of the aging temperature and the aging time to reach a target aging degree of the object based on at least one of the aging state, a type, and a capacity of the object.

The method may further include operating the aging chamber in a storage mode at a set temperature, in response to the measured aging state of the object exceeding the target aging degree of the object.

The performing of the aging process on the object may include: measuring an aging degree of the object at a preset interval; and determining whether the target aging degree is reachable within the aging time based on the measured aging degree of the object.

The method may further include transmitting, to a user terminal, a message inquiring about whether to adjust the aging temperature of the object based on the result of determination; and adjusting the aging temperature of the object based on a response to the message received from the user terminal

The receiving of the user feedback information may include: generating questions for an online survey about at least one of the aging degree of the object for which the aging process is completed in the aging chamber and food manufactured using the object and transmitting the generated questions to the user terminal; and receiving the user feedback information obtained through the online survey from the user terminal.

According to the disclosure, a refrigerator and a method for aging food using the same may effectively age an object stored in an aging chamber.

According to the disclosure, the refrigerator and the method for aging food using the same may perform an aging process in consideration of an aging state of the object stored in the aging chamber.

According to the disclosure, the refrigerator and the method for aging food using the same may receive user feedback information on an aging degree of the object and food manufactured using the object after completion of the aging process, and may control at least one of the aging temperature or the aging time when performing an aging process of the same object or the same type of object as the above object based on the user feedback information, thereby increasing user satisfaction.

The effects that may achieved by the disclosure are not limited to the above-mentioned effects, and other effects not mentioned will be clearly understood by one of ordinary skill in the technical art to which the disclosure belongs from the following description.

### DESCRIPTION OF DRAWINGS

FIG. 1 is a perspective view of a refrigerator according to an embodiment.

FIG. 2 is a side cross-sectional view of the refrigerator shown in FIG. 1.

FIG. 3 illustrates a portion of the refrigerator shown in FIG. 1.

FIG. 4 illustrates a state in which a drawer is withdrawn from a drawer case in the refrigerator shown in FIG. 3.

FIG. 5 illustrates a state in which the drawer case and the drawer are removed from the refrigerator shown in FIG. 3.

FIG. 6 illustrates a front of FIG. 5.

FIG. 7 illustrates a state in which a heating portion is separated from a storage compartment in the refrigerator shown in FIG. 5.

FIG. 8 is an exploded view of the heating portion shown in FIG. 7.

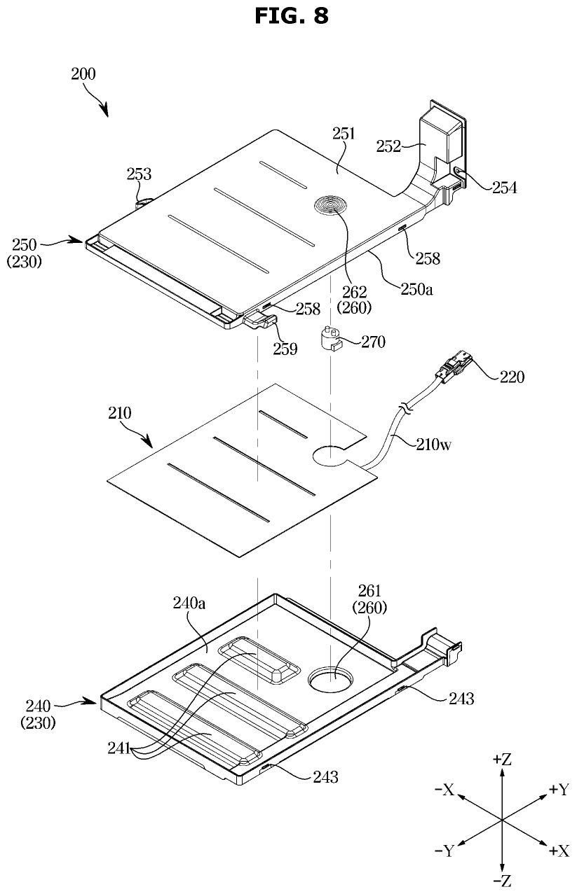

FIG. 9 is a control block diagram of a refrigerator according to an embodiment.

FIG. 10 illustrates an example of dough-related menus displayed on a display screen according to an embodiment.

FIG. 11 illustrates an example of user feedback related to food manufactured using an object for which aging is completed according to an embodiment.

FIG. 12 is a flowchart illustrating a method for aging food using a refrigerator according to an embodiment.

### MODES OF THE INVENTION

Embodiments of the disclosure and terms used herein are not intended to limit the technical features described herein to specific embodiments, and are intended to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “portion”, “module”, and “member” may be embodied as hardware or software. According to embodiments, a plurality of “unit”, “module”, and “member” may be implemented as a single component or a single “unit”, “module”, and “member” may include a plurality of components.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

The terms “front”, “rear”, “left”, “right”, “upper”, and “lower” used in the following description are defined based on the drawings, and the shape and location of each component are not limited by these terms. For example, based on the drawings, the front side (toward a door 30 based on a refrigerator 1) may be defined as the +X side and the rear side may be defined as the −X side. For example, based on the drawings, the right side may be defined as the +Y side and the left side may be defined as the −Y side. For example, based on the drawings, the upper side may be defined as the +Z side and the lower side may be defined as the −Z side.

Hereinafter, an operation principle and embodiments will be described in detail with reference to the accompanying drawings.

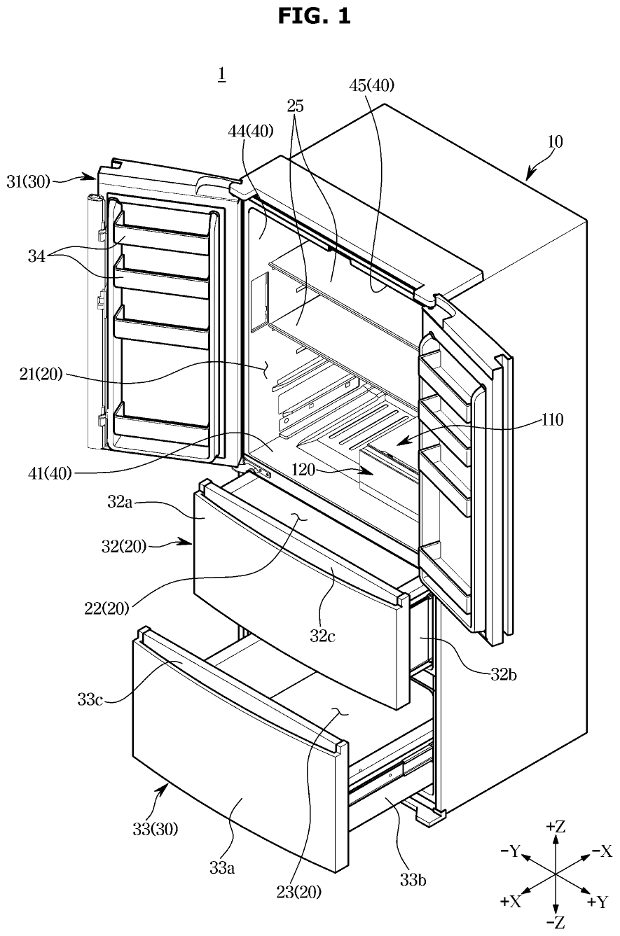

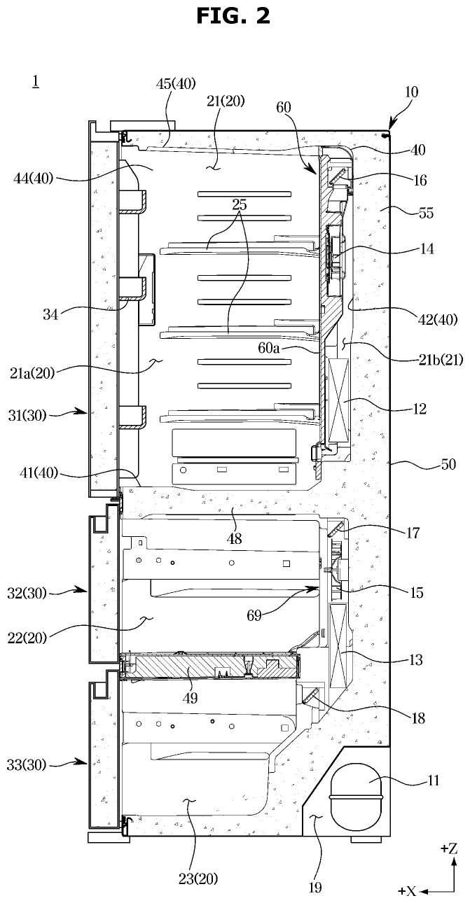

FIG. 1 is a perspective view of a refrigerator according to an embodiment, and FIG. 2 is a side cross-sectional view of the refrigerator shown in FIG. 1.

Referring to FIG. 1 and FIG. 2, the refrigerator 1 includes a main body 10 and a storage compartment 20 provided inside the main body 10.

The main body 10 may include an inner case 40 and an outer case 50.

The inner case 40 forms the storage compartment 20. For example, the inner case 40 may be made of a plastic material by a vacuum forming process or an injection molding process.

The outer case 50 is provided on the outer side of the inner case 40 to form an exterior of the refrigerator 1. The outer case 50 may be referred to as the cabinet, and may be made of a steel plate material.

An insulation 55 may be provided between the inner case 40 and the outer case 50. The insulation 55 may insulate the inside and the outside of the storage compartment 20 so that the temperature inside the storage compartment 20 may be maintained at a set temperature without being influenced by an external environment of the storage compartment 20.

For example, the insulation 55 may include urethane foam insulation, expanded polystyrene (EPS) insulation, vacuum insulation panel, and the like. Here, the vacuum insulation panel may include a core material and a cladding material accommodating the core material and sealing the inside with vacuum or pressure close to vacuum. The insulation may include various materials capable of being used for insulation.

The storage compartment 20 may be maintained within an appropriate temperature range according to the purpose of use, and may include a refrigerating compartment, a freezing compartment, or a temperature conversion compartment classified according to the purpose of use or temperature ranges. The refrigerating compartment may be maintained at an appropriate temperature to store items in a refrigerated manner, and the freezing compartment may be maintained at an appropriate temperature to store items in a frozen manner. The refrigerating may be keeping food cold without freezing the food, and for example, the refrigerating compartment may be maintained within a range of 0 degrees Celsius to 7 degrees Celsius. The freezing may be freezing food or keeping food frozen, and for example, the freezing compartment may be maintained within a range of −20 degrees Celsius to −1 degrees Celsius. The temperature conversion compartment may be used as either the refrigerating compartment or the freezing compartment according to or regardless of the user's selection.

The storage compartment 20 may also be referred to by various terms, such as a vegetable compartment, freshness compartment, cooling compartment, and ice-making compartment, in addition to the refrigerating compartment, the freezing compartment, and the temperature conversion compartment, and the terms, such as the refrigerating compartment, the freezing compartment, and the temperature conversion compartment, etc., as used below are to be understood as representing storage compartments having the corresponding purposes of use and the corresponding temperature ranges.

Inside the storage compartment 20, a shelf 25 on which food may be placed and a storage container (not shown) capable of accommodating food may be provided. The arrangement positions of the shelf 25 and the storage container may vary.

The storage compartment 20 may include a first storage compartment 21, a second storage compartment 22, and a third storage compartment 23 provided at the inner upper part, middle part, and lower part, respectively. The number and arrangement positions of the storage compartment 20 are not limited thereto, and two or fewer storage compartments or four or more storage compartments may be provided.

The inner case 40 may include a bottom wall 41, a rear wall 42, a right wall 43, a left wall 44, and a top wall 45 to form the first storage compartment 21.

A middle wall 48 may be arranged between the first storage compartment 21 and the second storage compartment 22. A partition 49 may be arranged between the second storage compartment 22 and the third storage compartment 23. The middle wall 48 may be provided as a part of the inner case 40, and the partition 49 may be detachable from the inner case 40.

The front of the storage compartment 20 may be opened and closed by the door 30 to allow food to be put in and taken out.

The door 30 may include a first door 31, a second door 32, and a third door 33. The first door 31 to the third door 33 may open and close the first storage compartment 21 to the third storage compartment 23, respectively.

The first door 31 may be coupled to the main body 10 so as to be rotatable in the left and right directions. A door guard 34 for storing food may be provided on the rear surface of the first door 31.

The second door 32 may be slidable to be inserted into the second storage compartment 22 or withdrawn from the second storage compartment 22. The second door 32 may include a door panel 32a covering the open front of the second storage compartment 22 and provided with a handle 32c, and a basket 32b coupled to the rear surface of the door panel 32a.

The third door 33 may be slidable to be inserted into the third storage compartment 23 or withdrawn from the third storage compartment 23. The third door 33 may include a door panel 33a covering the open front of the third storage compartment 23 and provided with a handle 33c, and a basket 33b coupled to the rear surface of the door panel 33a.

The refrigerator 1 may be classified as French Door Type, Side-by-side Type, Bottom Mounted Freezer (BMF), Top Mounted Freezer (TMF), or single door refrigerator according to the arrangement of the doors 30 and the storage compartments 20.

The refrigerator 1 may include a cold air supply device for generating cold air using a cooling cycle and supplying the generated cold air to the storage compartment 20. The cold air supply device may include a machine, an apparatus, an electronic device, and a combination system thereof capable of generating cold air and guiding the cold air to cool the storage compartment. The cold air supply device may include a semiconductor, such as a thermoelectric element. The thermoelectric element may cool the storage compartment 20 by heating and cooling actions through the Peltier effect.

Specifically, the cold air supply device may include a compressor 11, evaporators 12 and 13, and blower fans 14 and 15. At least some of the components of the cold air supply device may be disposed in a machine compartment 19. For example, the compressor 11 may be disposed in the machine compartment 19. The machine compartment 19 may be partitioned and insulated from the storage compartment 20 to prevent heat generated from components disposed inside the machine compartment 19 from being transferred toward the storage compartment 20. The machine compartment 19 may communicate with the outside of the main body 10 to dissipate heat from components installed inside the machine compartment 19.

The compressor 11 may compress a refrigerant at high temperature and high pressure. The refrigerant compressed by the compressor 11 may pass through the condenser (not shown). The compressor 11 may operate the cooling cycle of the refrigerator 1.

The evaporators 12 and 13 may include the first evaporator 12 and the second evaporator 13. The first evaporator 12 may cool air recovered from the first storage compartment 21 and generate cold air to be supplied to the first storage compartment 21. The second evaporator 13 may cool air recovered from the second storage compartment 22 and the third storage compartment 23 and generate cold air to be supplied to the second storage compartment 22 and the third storage compartment 23.

The blower fans 14 and 15 may include the first blower fan 14 and the second blower fan 15. The first blower fan 14 may cause the cold air generated by the first evaporator 12 to flow. The second blower fan 15 may cause the cold air generated by the second evaporator 13 to flow.

The refrigerator 1 may include a first damper 16, a second damper 17, and a third damper 18. The first damper 16 may adjust the amount of cold air supplied to the first storage compartment 21. The second damper 17 may adjust the amount of cold air supplied to the second storage compartment 22. The third damper 18 may adjust the amount of cold air supplied to the third storage compartment 23.

The refrigerator 1 may include a first duct 60 and a second duct 69.

The first duct 60 may guide the cold air generated by the first evaporator 12 to the first storage compartment 21. The first duct 60 may be disposed at the rear part of the first storage compartment 21 to face the rear wall 42 of the inner case 40. The first duct 60 may accommodate the first blower fan 14 and the first damper 16. The first duct 60 may partition the first storage compartment 21 into a storage space 21a where food is stored and a cooling space 21b where the first evaporator 12 is disposed.

The second duct 69 may guide the cold air generated by the second evaporator 13 to the second storage compartment 22 and the third storage compartment 23. The second duct 69 may be disposed at the rear part of the second storage compartment 22 and the third storage compartment 23. The second duct 69 may accommodate the second blower fan 15, the second damper 17, and the third damper 18. In another example, the first duct 60 and the second duct 69 may be integrally provided.

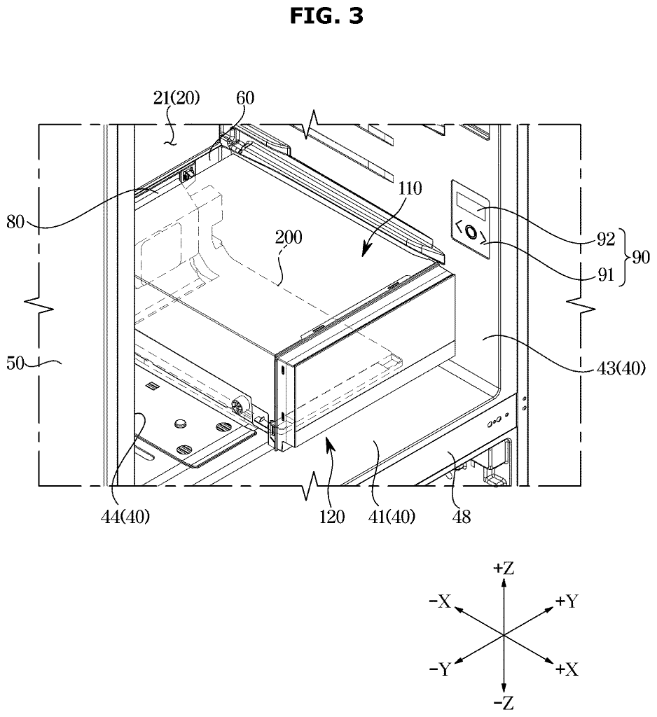

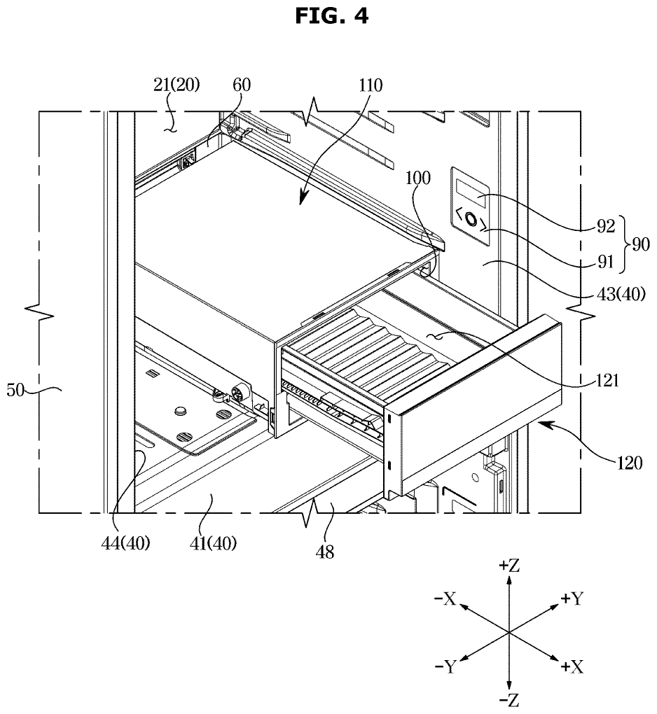

FIG. 3 illustrates a portion of the refrigerator shown in FIG. 1, and FIG. 4 illustrates a state in which the drawer is withdrawn from the drawer case in the refrigerator shown in FIG. 3.

Referring to FIG. 3 and FIG. 4, the refrigerator 1 may include a user interface 90 and an aging chamber 100.

The user interface 90 may enable interaction with a user through various elements, such as graphics, text, voice, touch, virtual reality, and augmented reality.

The user interface 90 may include a display screen 92 and a menu button 91 displaying menus and various information. The user may select a desired menu by directly touching the display screen 92, or may select a menu using the menu button 91. The user interface 90 may be disposed on the right wall 43, but is not limited thereto, and may be located at various positions of the refrigerator 1.

In a case where kimchi is stored in the aging chamber 100, the user interface 90 may provide a menu on the display screen 92 to allow the user to select at least one of the type, the manufacturing date, the target aging degree, the purpose of aging, and the capacity of the kimchi.

In a case where dough is stored in the aging chamber 100, the user interface 90 may provide a menu on the display screen 92 to allow the user to select at least one of the type, the capacity, and the target aging degree of the dough.

The user interface 90 may receive user feedback information on at least one of the aging degree of the object (e.g., kimchi, dough) for which the aging process is completed in the aging chamber 100 and food manufactured using the object.

To this end, the user interface 90 may display online survey questions on the display screen 92 to allow a user to check whether a target aging degree desired by the user has been reached for the object for which the aging process is completed, or to check satisfaction with food manufactured using the object for which the aging process is completed.

In another example, the user interface 90 may receive, from a user terminal, user feedback information on at least one of the aging degree of the object for which the aging process is completed in the aging chamber 100 and food manufactured using the object.

The aging chamber 100 may be disposed in at least one of the first storage compartment 21, the second storage compartment 22, and the third storage compartment 23. In the embodiment, it is described as an example that the aging chamber 100 is disposed inside the first storage compartment 21.

The aging chamber 100 may enable independent temperature control, separately from the first storage compartment 21. Food including kimchi, dough, meat, wine, and the like, may be stored in the aging chamber 100 to undergo an aging process. For convenience of description, in the embodiment of the disclosure, food stored in the aging chamber 100 for aging is described as an ‘object’. For reference, according to the WHO definition, anything that is completely processed, partially processed, or edible without processing for human consumption is defined as food.

The aging chamber 100 may be changed to a storage mode after the aging process of the object stored in the aging chamber 100 is completed in order to store the aged object at a set temperature. In this instance, a set temperature in the aging chamber 100 may be the same as that of the first storage compartment 21.

The refrigerator 1 may include a drawer case 110 and a drawer 120. The drawer case 110 may be disposed inside the first storage compartment 21. The drawer case 110 may be disposed in front of the cooling portion 80 configured to reduce the temperature inside the aging chamber 100. The drawer case 110 may be disposed above the heating portion 200 configured to increase the temperature inside the aging chamber 100.

The drawer case 110 may form the aging chamber 100. The drawer case 110 may accommodate the drawer 120. The drawer case 110 may have an open front.

The drawer 120 may be detachably mounted on the drawer case 110. The drawer 120 may be inserted into the drawer case 110 or withdrawn from the drawer case 110. The drawer 120 may have a shape with an open top side.

The drawer 120 may include a storage space 121 in which kimchi, dough, meat, wine, vegetables, and the like, is stored.

As the drawer 120 is inserted into the drawer case 110, the storage space 121 of the drawer 120 may be accommodated in the aging chamber 100.

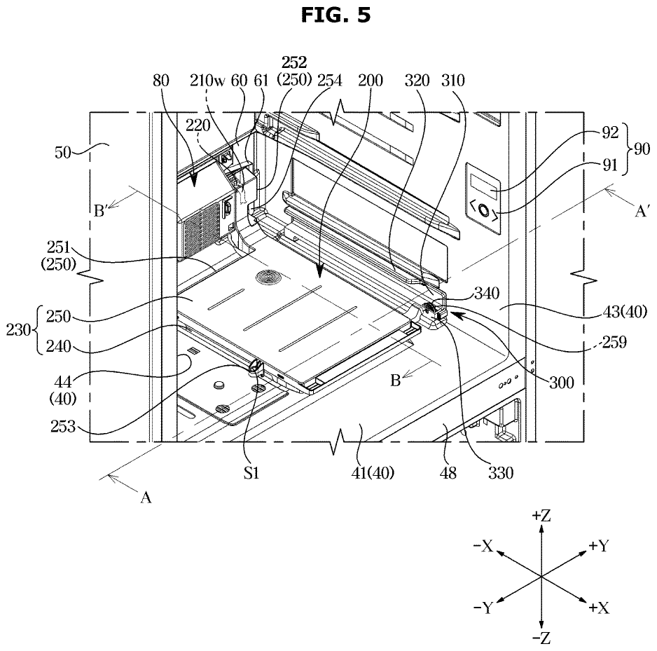

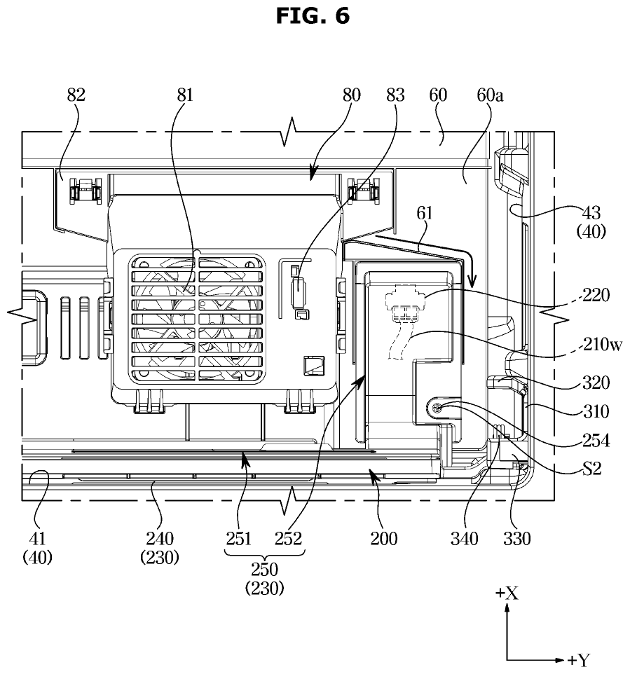

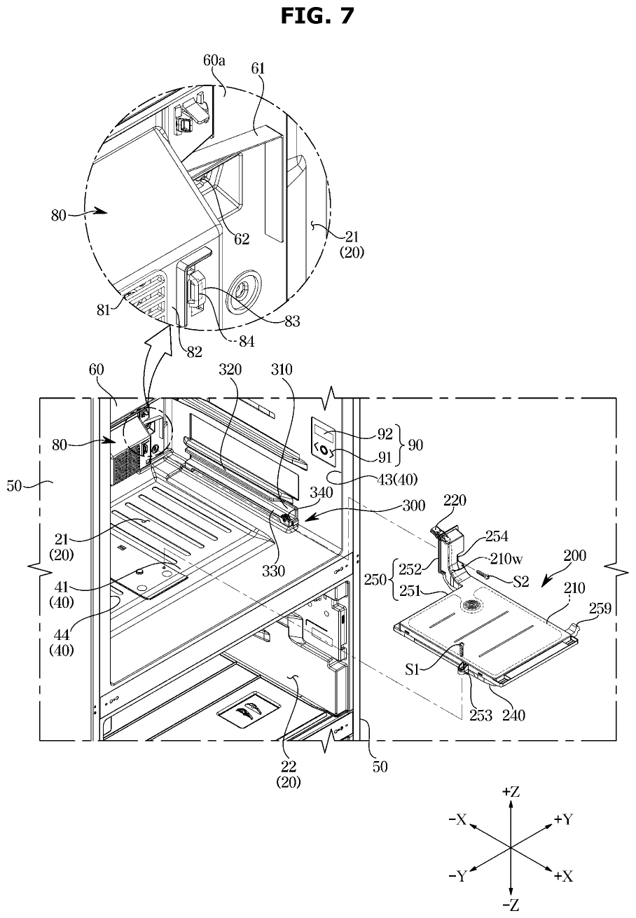

FIG. 5 illustrates a state in which the drawer case and the drawer are removed from the refrigerator shown in FIG. 3, and FIG. 6 illustrates the front of FIG. 5. FIG. 7 illustrates a state in which the heating portion is separated from the storage compartment in the refrigerator shown in FIG. 5.

Referring to FIG. 5 to FIG. 7, a side frame 300 may be provided in the first storage compartment 21. The side frame 300 may be detachably mounted on at least one of both side walls 43 and 44 of the inner case 40. The side frame 300 may fix the drawer case 110 to at least one of both side walls 43 and 44 of the inner case 40.

The side frame 300 may include a fixed panel 310 fixable to the right wall 43 of the inner case 40. The side frame 300 may include a first extension portion 320 protruding toward the inside of the inner case 40 from the fixed panel 310. The side frame 300 may include a second

extension portion 330 spaced apart from the first extension portion 320 in a downward direction and protruding toward the inside of the inner case 40 from the fixed panel 310. A rail may be formed between the first extension portion 320 and the second extension portion 330. The drawer case 110 may be detachably mounted on the rail formed between the first extension portion 320 and the second extension portion 330.

The side frame 300 may include a rail roller 340 provided on the second extension portion 330. The rail roller 340 may guide the drawer case 110 mounted on the rail formed between the first extension portion 320 and the second extension portion 330.

The cooling portion 80 and the heating portion 200 may be arranged in the first storage compartment 21.

The cooling portion 80 may reduce the internal temperature of the aging chamber 100. The cooling portion 80 may be provided to face the rear surface of the drawer case 110.

The cooling portion 80 may be disposed outside the aging chamber 100, thereby improving space utilization of the aging chamber 100. The drawer 120 may be smoothly detachable from the drawer case 110 without interfering with the cooling portion 80.

The cooling portion 80 may include a fan 81 for flowing air in

the first storage compartment 21 into the aging chamber 100. The fan 81 may be accommodated in a fan case 82, and the fan case 82 may be detachably mounted on the front 60a of the duct 60.

A third sensor 84 for detecting the temperature of the aging chamber 100 may be provided on the cooling portion 80 side. The third sensor 84 may be detachably mounted on a temperature sensor mounting portion 83 formed in the fan case 82.

The heating portion 200 may increase the internal temperature of the aging chamber 100. The heating portion 200 may be disposed outside the aging chamber 100 to heat the lower part of the aging chamber 100. The drawer 120 may be smoothly detachable from the drawer case 110 without interfering with the heating portion 200.

The heating portion 200 may include a heater 210 and a connector 220.

The heater 210 may heat air inside the aging chamber 100, and may have, for example, a plate shape. The heater 210 may include two aluminum sheets and a heating wire disposed therebetween.

The connector 220 may supply power to the heater 210, and may be provided at one end of a wire 210w of the heater 210. The connector 220 may be provided to face the rear of the first storage compartment 21. The connector 220 may be mountable on the duct 60. The connector 220 may be mountable on the front 60a of the duct 60. The

connector 220 may be insertable into a connector hole 62 of the duct 60.

The heater 210 may be accommodated in a heater case 230. The heater case 230 may accommodate a bimetal 270. The heater case 230 may cover the connector 220 mounted on the duct 60. Accordingly, the heater case 230 may prevent moisture from flowing into the connector 220 mounted on the duct 60.

The heater case 230 may include a lower frame 240. The heater case 230 may include an upper frame 250.

The lower frame 240 may be seated on the bottom wall 41 of the inner case 40. The lower frame 240 may be placed on the bottom wall 41 of the inner case 40. The lower frame 240 may have a shape with an approximately open top side.

The upper frame 250 may be detachably coupled to the lower frame 240. The upper frame 250 may cover the upper part of the lower frame 240.

The upper frame 250 may include a body portion 251 and a cover portion 252. The body portion 251 may be disposed below the aging chamber 100. The body portion 251 may support the lower part of the aging chamber 100. The body portion 251 may be coupleable with the lower surface of the drawer case 110.

The cover portion 252 may cover the connector 220 mounted on the duct 60. The cover portion 252 may extend upward from the rear of the body portion 251. The cover portion 252 may be located behind the aging chamber 100. The cover portion 252 may be provided to face the

rear surface of the drawer case 110. The cover portion 252 may be coupleable to the front 60a of the duct 60.

A guide rib 61 may be provided on the cover portion 252. The guide rib 61 may guide moisture away from the cover portion 252 and the connector 220 covered by the cover portion 252. For example, the guide rib 61 may have a shape inclined downward toward one side wall 43 or 44 of the inner case 43, and may guide moisture downward. Moisture guided by the guide rib 61 may fall toward the bottom wall 41 of the inner case 40.

The heating portion 200 may be separable from the first storage compartment 21. The heater case 230 may be detachably coupled to the bottom wall 41 of the inner case 40 and the front of the duct 60. The heater case 230 may include a first coupling portion 253 coupleable to the bottom wall 41 of the inner case 40 and a second coupling portion 254 coupleable to the front 60a of the duct 60.

The first coupling portion 253 may be formed on the body portion 251 of the upper frame 250, and a first fastening member S1 may fix the first coupling portion 253 to the bottom wall 41 of the inner case 40. The second coupling portion 254 may be formed on the cover portion 252 of the upper frame 250, and a second fastening member S2 may fix the second coupling portion 254 to the front 60a of the duct 60. The body portion 251 of the upper frame 250 may include a fixed rib 259. The fixed rib 259 may be inserted between the bottom wall 41 of the inner case 40 and the second extension portion 330 of the side frame 300.

The heating portion 200 may include the bimetal 270. The bimetal 270 may be provided to prevent overheating of the heater 210. The bimetal 270 may be accommodated in the heater case 230. The heater case 230 may include a bimetal mounting portion 260 on which the bimetal 270 is mounted. For example, the bimetal mounting portion 260 may include a seating portion 261 formed on the lower frame 240 and on which the lower part of the bimetal 270 is seated, and a fixed portion 262 formed on the upper frame 250 and to which the upper part of the bimetal 270 is fixed.

The heater 210 may be mounted on the inner surface of the heater case 230. The heater 210 may be mounted on the inner surface of the upper frame 250. The heater 210 may be attached to the inner top surface 250a of the body portion 251 of the upper frame 250.

The lower frame 240 may include a protrusion 241. The protrusion 241 may support the heater 210 to prevent the heater 210 from being separated from the upper frame 250. The protrusion 241 may be provided to come into contact with the heater 210 to prevent the heater 210 from being detached from the upper frame 250. The protrusion 241 may protrude upward. The protrusion 241 may extend from the bottom 240a of the lower frame 240 toward the inner top surface 250a of the upper frame 250. The protrusion 241 may bring the heater 210 and the upper frame 250 into close contact.

The heater 210 may be maintained in a state of being mounted on the upper frame 250 by the protrusion 241. Through the above, the heating portion 200 may effectively heat the aging chamber 100.

The upper frame 250 may be provided with a hook hole 258 formed on the edge. The hook hole 258 may be located at a position corresponding to a hook 243 on the edge of the lower frame 240. As the hook 243 is inserted into the hook hole 258, the upper frame 250 and the lower frame 240 may be closely coupled.

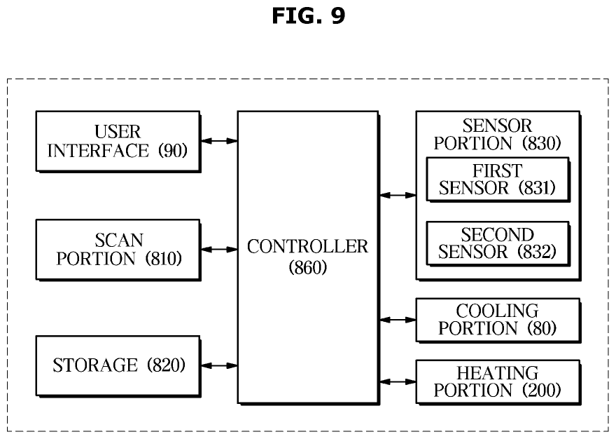

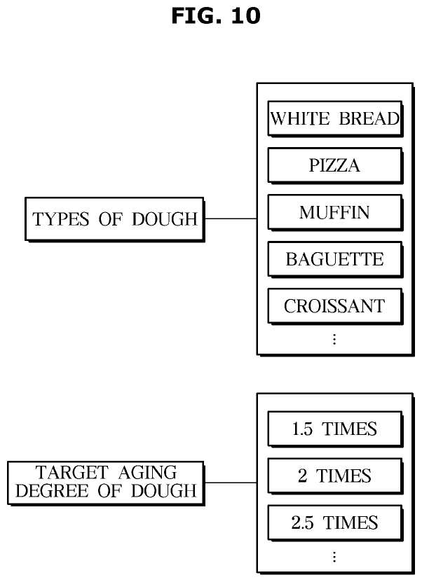

FIG. 9 is a control block diagram of the refrigerator according to an embodiment, and FIG. 10 illustrates an example of dough-related menus displayed on the display screen according to an embodiment.

Hereinafter, redundant contents described above will be omitted, and kimchi or dough will be described as an example.

Referring to FIG. 9, the refrigerator 1 may include a scan portion 810, a storage 820, a first sensor 831, a second sensor 832, and a controller 860. In addition, the refrigerator 1 may include the user interface 90, the cooling portion 80, the heating portion 200, and the third sensor 84 as described above.

The user interface 90 (see FIG. 4) may provide a menu on the

display screen to allow a user to input at least one of the type, the manufacturing date, the target aging degree, the purpose of aging, and the capacity of an object, when the object to be aged is stored in the aging chamber 100. The user interface 90 may enable interaction with the user through various elements, such as graphics, text, voice, touch, virtual reality, and augmented reality.

For example, the user may select the type of kimchi stored in

the aging chamber 100 through the user interface 90. Kimchi may include various types, such as baechu-kimchi, dongchimi, kkakdugi, gat-kimchi, yeolmu-kimchi, mugeun-ji, and the like.

Kimchi may be manufactured by an individual, and may be manufactured in a manufacturing plant for commercial sale. The user may select the manufacturing date of kimchi through the user interface 90.

An aging degree may be classified into, for example, an unripe stage, a ripe stage, and a fully-ripe stage. In another example, the classification of the aging degree may be further subdivided to include more aging stages between unripe and ripe stages, or between ripe and fully-ripe stages. The user may select a target aging degree desired by the user through the user interface 90.

The fully-ripe kimchi may be used for cooking various foods, such as kimchi fried rice, kimchi pancake, kimchi stew, kimchi buchimgae,

kimchi fried noodles, and the like. The user may select the type of food to be made using kimchi as the purpose of aging through the user interface 90.

Kimchi contained in a container or package may be stored in the aging chamber 100, and the capacity of kimchi may be generally indicated in units of kilograms. The capacity of kimchi may be automatically measured by, for example, a weight sensor (not shown), or the user may select the capacity through the user interface 90. In the case of packaged kimchi, the capacity marked on the package may be scanned and stored by the scan portion 810 to be described later.

In a case where dough is stored in the aging chamber 100, the user interface 90 may provide a menu on the display screen to allow a user to input at least one of the type, the capacity, and the target aging degree of the dough.

The dough stored in the aging chamber 100 may be used to manufacture various foods, such as white bread, pizza, muffins, baguettes, croissants, and the like, after an aging process. The dough may contain different amounts of flour, salt, water, sugar, fat, yeast, and the like, depending on the purpose.

The type of dough corresponds to the purpose of aging of the dough, and may correspond to the type of food to be manufactured using the dough. To this end, the user interface 90 may display the type of food to be manufactured using the dough on the display screen.

For example, referring to FIG. 10, when the user selects the type of dough from the dough-related menus displayed on the display screen, sub-menus such as white bread, pizza, muffins, baguettes, croissants, and the like, may be displayed, and the user may select a menu item corresponding to the purpose of aging of the dough from among the menus. For example, when the user selects white bread, white bread may be input as the type of dough.

In addition, the user may select the volume of the dough as the target aging degree of the dough. To this end, the user interface 90 may display the volume of the dough on the display screen.

Referring to FIG. 10, when the user selects a target aging degree of the dough from the dough-related menus displayed on the display screen, sub-menus such as 1.5 times, 2 times, 2.5 times, and the like, may be displayed, and a desired volume of the dough may be selected. The volume of the dough may gradually increase during the aging process, compared to the initial volume after being initially stored in the aging chamber 100.

In addition, although not shown, menus required for the aging process of the dough may be provided. For example, the user may select the capacity of the dough in units such as grams (g) or kilograms (kg).

The user interface 90 may display a menu for selecting a consumption date of kimchi stored in the aging chamber 100 on the display screen. That is, when the user selects a date to consume kimchi, the kimchi may be aged by the consumption date.

For example, in a case where a packaged product is stored in the aging chamber 100, the scan portion 810 may scan at least one of the product name, the manufacturing date, the capacity, and the barcode displayed on the package.

The information scanned by the scan portion 810 may be stored in the storage 820. As a result, the amount of information to be input through the user interface 90 may be reduced.

The storage 820 may include a memory. The memory may store programs, applications, and/or data for operation control of the refrigerator 1, and may store data generated by a processor (not shown). The memory may include non-volatile memory such as read only memory (ROM) and flash memory for long-term data storage. The memory may include volatile memory such as static random access memory (S-RAM) and dynamic random access memory (D-RAM) for temporarily storing data.

The storage 820 may store at least one of the aging degree, the type, and the capacity of the object stored in the aging chamber 100. In addition, the storage 820 may store various data, such as information input via the user interface 90, information scanned by the scan portion 810, values measured by the first sensor 831, the second sensor 832, and the third sensor 84, the set temperature of the aging chamber 100, product information of the refrigerator 1, user information, information about the object aged in the aging chamber 100, user feedback information about at least one of the aging degree of the object for which the aging process is completed and food manufactured using the object, aging temperature, aging time, and the like.

The sensor portion 830 may measure the aging degree of the object to be aged in the aging chamber 100. The sensor portion 830 may include the first sensor 831 and the second sensor 832. In addition, although not shown in FIG. 9, the sensor portion 830 may include the above-described third sensor 84.

The first sensor 831 measures the aging degree of kimchi stored in the aging chamber 100. The first sensor 831 may include a sensor for measuring pH representing the aging degree of kimchi. For example, in the initial stage of kimchi, fermentation activity of microorganisms does not occur significantly, and thus the kimchi may have a pH value of 5 or more. In the ripe stage, as kimchi ages, the activity of microorganisms increases, and thus pH decreases and a pH value may be between approximately 4.5 and 5.0. In the fully-ripe stage, the activity of microorganisms is stabilized, and the pH is maintained in a relatively stable range, i.e., a pH value of less than approximately 4.5.

When kimchi is stored in the aging chamber 100, the aging state of the kimchi may be measured by the first sensor 831 before the aging process is performed in the aging chamber 100. Accordingly, the current aging state of the kimchi since its manufacture may be identified.

The first sensor 831 may measure the aging degree of the kimchi stored in the aging chamber 100 at a preset interval during the aging process.

The second sensor 832 measures the aging degree of dough when the dough is stored in the aging chamber 100. The second sensor 832 may include a camera for detecting the size of the dough to measure its aging degree. That is, the aging degree of the dough is reflected in the size of the dough, and thus the greater the aging degree, the larger the size of the dough.

When the dough is stored in the aging chamber 100, the aging state of the dough may be measured by the second sensor 832 before the aging process is performed in the aging chamber 100. Accordingly, the current aging state of the dough since its manufacture may be identified.

The second sensor 832 may measure the aging degree of the dough stored in the aging chamber 100 at a preset interval during the aging process.

The controller 860 may control overall operations and functions of the refrigerator 1, and may include a processor and a memory. The processor may include logic circuitry and arithmetic circuitry in hardware. The processor may control electrically connected components of the refrigerator 1 using programs, instructions, and/or data stored in the memory for the operation of the refrigerator 1. The processor and the memory may be implemented as separate chips or as a single chip. In addition, the controller 190 may include a plurality of processors and a plurality of memories. The memory may be included in the above-described storage 820.

The controller 860 may include a communication module (not shown). The communication module may communicate with external devices such as servers, mobile devices, and other home appliances through a nearby access point (AP). The access point (AP) may connect a local area network (LAN) to which the refrigerator 1 or a user terminal is connected to a wide area network (WAN) to which a server is connected. The refrigerator 1 or the user terminal may be connected to the server through the wide area network (WAN).

The controller 860 may allow the aging process to be performed in the aging chamber 100 based on the aging temperature and the aging time. The controller 860 may control the aging temperature of the aging chamber 100 by the cooling portion 80 and the heating portion 200, so that the aging process for the object to be aged (e.g., kimchi or dough) is performed for a preset aging time.

For example, the controller 860 may set the aging temperature and the aging time to reach a target aging degree of kimchi based on at least one of the aging state of the kimchi measured by the first sensor 831, the type of the kimchi, and the capacity of the kimchi.

When kimchi is stored in the aging chamber 100, the aging state of the kimchi is measured by the first sensor 831. In a case where the aging process is performed in the aging chamber 100 without considering the aging state of the kimchi, its peak maturity period may be exceeded, and thus the storage period of the kimchi may be shortened. In addition, in a case where the aging process is completed before the peak maturity period is reached, an additional aging process is required. Accordingly, in the embodiment, the aging process may be performed in consideration of the aging state of the kimchi measured by the first sensor 831.

Specifically, in the case of baechu-kimchi and dongchimi, the controller 860 may set the aging temperatures to be the same and set the aging time of dongchimi to be longer than that of baechu-kimchi based on at least one of the aging state, type, and capacity of each. In a case where baechu-kimchi and dongchimi are simultaneously stored in the aging chamber 100, the aging process of baechu-kimchi may be completed first.

For example, the controller 860 may set the aging temperature and the aging time to reach a target aging degree of dough based on at least one of the aging state of the dough measured by the second sensor 832, the type of the dough, and the capacity of the dough. When dough is stored in the aging chamber 100, high-quality aging may be achieved by performing the aging process in consideration of the aging state of the dough, similar to the kimchi described above.

For example, during the aging process of kimchi stored in the aging chamber 100, the controller 860 may measure the aging degree of the kimchi using the first sensor 831 at a preset interval, and may determine whether a target aging degree may be reached within the aging time based on the aging degree of the kimchi measured at a preset interval. In addition, the controller 860 may adjust the aging temperature of the kimchi so that the target aging degree may be reached within the set aging time based on the determination result.

In this instance, the controller 860 may transmit a message inquiring about whether to adjust the aging temperature of the kimchi to the user terminal based on the above determination result. In addition, the controller 860 may adjust the aging temperature of the kimchi based on a response to the message received from the user terminal. For example, when the user agrees to the adjustment of the aging temperature of the kimchi through the user terminal, the controller 860 may adjust the aging temperature of the kimchi based on the response. In addition, in a case where the user directly inputs the aging temperature of the kimchi through the user terminal, the controller 860 may adjust the aging temperature of the kimchi according to the value input by the user.

When the aging process of the kimchi stored in the aging chamber 100 is completed, the controller 860 may transmit an aging completion message to the user terminal. In another example, the controller 860 may display the aging completion message on the display screen 92 of the user interface 90.

In a case where the aging state of the kimchi measured by the first sensor 831 exceeds the target aging degree of the kimchi, the controller 860 may operate the aging chamber 100 in a storage mode. The controller 860 may set the temperature of the aging chamber 100 to be the same as the temperature of the first storage compartment 21 (see FIG. 4) when operating in the storage mode.

In a case where the user selects a consumption date of the kimchi stored in the aging chamber 100 through the user interface 90, the controller 860 may control the aging process of the kimchi so that the kimchi may be aged by the consumption date. In this instance, the controller 860 may control the aging process of the kimchi by setting the aging temperature to reach the target aging degree of the kimchi input through the user interface 90, based on at least one of the type, the capacity, and the consumption date of the kimchi.

During the aging process of the dough stored in the aging chamber 100, the controller 860 may measure the size of the dough by the second sensor 832 at a preset interval, may determine whether a target aging degree may be reached within the aging time, set by the controller 860, based on the measured size of the dough, and may adjust the aging temperature of the dough based on the determination result.

In this instance, the controller 860 may transmit a message inquiring about whether to adjust the aging temperature of the dough to the user terminal based on the determination result, and may adjust the aging temperature of the dough based on a response to the message received from the user terminal.

When the aging process of the dough stored in the aging chamber 100 is completed, the controller 860 may transmit an aging completion message to the user terminal. In another example, the controller 860 may display the aging completion message on the display screen 92 of the user interface 90.

The controller 860 may control the cooling portion 80 for lowering the temperature inside the aging chamber 100 or the heating portion 200 for increasing the temperature inside the aging chamber 100 to adjust the aging temperature of the aging chamber 100, based on the temperature detected by the third sensor 84 (see FIG. 7) that senses the temperature inside the aging chamber 100.

The controller 860 may receive, from the user terminal or the user interface 90 of the refrigerator 1, user feedback information on at least one of the aging degree of the object for which the aging process is completed in the aging chamber 100 and food manufactured using the object.

The controller 860 may control at least one of the aging temperature and the aging time based on the user feedback information. In this instance, when performing the aging process of the same object or the same type of object as that associated with the user feedback, the controller 860 may control at least one of the aging temperature and the aging time of the object.

For example, after the aging process of the dough for manufacturing white bread stored in the aging chamber 100 is completed, the user may provide satisfaction feedback on the aging degree of the dough through an online survey. In addition, the user may provide satisfaction feedback on the quality of white bread manufactured using the dough through an online survey. The user feedback information may be reflected in adjusting the aging temperature and the aging time of the dough when performing a subsequent aging process of dough for manufacturing white bread.

To this end, the controller 860 may request feedback from the user by providing an online survey via an e-mail including a link, an application, or a mobile platform.

The controller 860 may receive feedback information from the user by providing the online survey on the user terminal or the display screen 92 of the user interface 90.

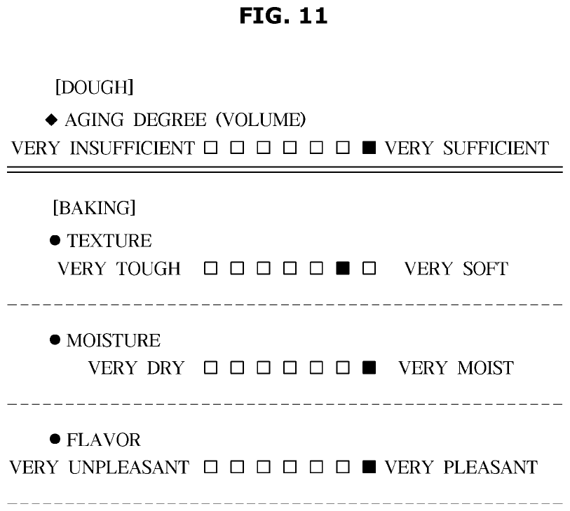

FIG. 11 illustrates an example of user feedback related to food manufactured using an object for which aging is completed according to an embodiment.

Referring to FIG. 11, in the online survey described above, user feedback on the aging degree of the dough for which the aging process is completed and on bread manufactured using the dough may be provided. In this instance, feedback on texture, moisture, and flavor may be provided. For example, feedback on the aging degree of the dough may be provided by allowing the user to select a degree ranging from “very insufficient” to “very sufficient”. In addition, feedback on the texture may be provided by allowing the user to select a degree ranging from “very tough” to “very soft”.

The controller 860 may determine the aging time using [Equation 1] below, based on the user feedback information obtained through the online survey.

aging time=a*aging degree+b*texture+c*moisture+d*flavor [Equation 1]

Here, a, b, c, and d are coefficients for each characteristic, and an absolute value may increase as a characteristic has a greater influence on the aging time.

The aging time determined using [Equation 1] may be applied when performing the aging process of the same object or the same type of object as that associated with the user feedback.

The controller 860 may generate questions for the online survey based on, for example, information input through the user interface 90 and stored in the storage 820, information scanned by the scan portion 810, values measured by the sensors, product information of the refrigerator 1, user information, information related to an object aged in the aging chamber 100, aging temperature, aging time, and the like.

The questions for the online survey may include content for checking the user satisfaction with at least one of the aging degree of the object for which the aging process is completed in the aging chamber 100 and food manufactured using the object.

For example, the user may check an extent to which the target aging degree has actually been reached for the kimchi or dough for which the aging process is completed through the online survey received via the user terminal.

The controller 860 may provide the online survey so that the user may check whether the target aging degree has been reached for the object for which the aging process is completed by dividing the aging degree into several stages. Specifically, in a case where the target aging degree of the kimchi for which the aging process is completed is fully-ripe

stage, the controller 860 may provide the online survey by dividing a target aging degree achievement score ranging from 100% to 10%. For example, the user may select 100% when very satisfied, and select 10% when determined that the target aging degree has not been reached at all. The controller 860 may adjust at least one of the aging temperature and the aging time differently from a previous set value in consideration of the user feedback information in the next aging process of kimchi.

In addition, the user may check the quality of bread manufactured using the dough for which the aging process is completed through the online survey. Specifically, the user may check the flavor of the bread (e.g., yeast flavor, toasted flour flavor, etc.) and texture (e.g., moistness, softness, crispness, etc.).

The controller 860 may provide the online survey so that the user may check the quality of the bread by dividing the quality into several stages. Specifically, the controller 860 may receive feedback information from the user by dividing the stages into very firm, firm, normal, soft, very soft, and the like. For example, in a case where the user selects the quality of the bread as very firm, the controller 860 may adjust at least one of the aging temperature and the aging time differently from a previous set value in consideration of the user feedback information in the next aging process of the dough.

The user feedback information may be accumulated and stored in the storage 820, and the controller 860 may analyze the accumulated data and control at least one of the aging temperature and the aging time for an efficient aging process.

The controller 860 may receive the results of the online survey from the user terminal, analyze the result for each question, and reflect the analyzed result when performing the aging process of the same object or the same type of object as that associated with the user feedback, thereby adjusting at least one of the aging temperature and the aging time.

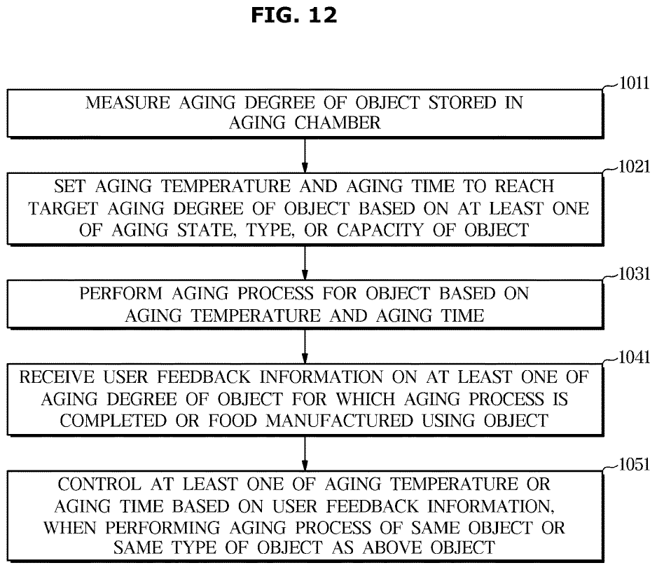

FIG. 12 is a flowchart illustrating a method for aging food using a refrigerator according to an embodiment.

Referring to FIG. 12, the sensor portion 830 measures an aging state of an object stored in the aging chamber 100 (1011).

In a case where the aging state of the object stored in the aging chamber 100 measured by the sensor portion 830 exceeds a target aging degree, the controller 860 may operate the aging chamber 100 in the storage mode at a set temperature without performing an aging process. For example, in a case where the current aging state of the kimchi stored in the aging chamber 100 has already exceeded the ripe stage, which is the target aging degree, the aging chamber 100 may be operated in the storage mode at a set temperature.

Specifically, in a case where kimchi is stored in the aging chamber 100, the user interface 90 may provide a menu on the display screen 92 so that a user may select at least one of the type of kimchi, the manufacturing date, the target aging degree, the purpose of aging, and the capacity of the kimchi. The controller 860 compares the target aging degree selected by the user on the menu of the display screen 92 with the aging state of the object stored in the aging chamber 100 measured by the sensor portion 830, and in a case where the aging state of the object stored in the aging chamber 100 measured by the sensor portion 830 exceeds the target aging degree, the aging chamber 100 is operated in the storage mode.

The controller 860 sets the aging temperature and the aging time to reach the target aging degree which is set for the object, based on at least one of the aging state, the type, and the capacity of the object stored in the aging chamber 100 (1021).

The controller 860 performs the aging process for the object stored in the aging chamber 100 based on the aging temperature and the aging time (1031).

During the aging process of the object, the controller 860 may control the sensor portion 830 to measure an aging degree of the object at a preset interval, and determine whether the target aging degree may be reached within the aging time based on the measured aging degree of the object.

In addition, the controller 860 may transmit, to a user terminal, a message inquiring about whether to adjust the aging temperature of the object based on the determination result, and may adjust the aging temperature of the object based on a response to the message received from the user terminal.

When the aging process is completed, the controller 860 may transmit an aging completion message to the user terminal.

The controller 860 receives user feedback information on at least one of the aging degree of the object for which the aging process is completed and food manufactured using the object (1041).

To this end, the controller 860 may generate questions for an online survey on at least one of the aging degree of the object (e.g., dough) for which the aging process is completed in the aging chamber 100 and food manufactured using the object, and may transmit the questions to the user terminal.

In addition, the controller 860 may receive the user feedback information obtained through the online survey from the user terminal. In another example, the controller 860 may receive the user feedback information by providing the online survey through the user interface 90 of the refrigerator 1.

The controller 860 controls at least one of the aging temperature and the aging time based on the user feedback information (1051). In this instance, based on the user feedback information, the controller 860 may control at least one of the aging temperature and the aging time of the object when performing the aging process of the same object or the same type of object as the object for which the aging process was completed in the aging chamber 100.

According to various embodiments, the method according to the various embodiments disclosed herein may be provided in a computer program product. The computer program product may be a commercial product that may be traded between a seller and a buyer. The computer program product may be distributed in the form of a storage medium (e.g., a compact disc read only memory (CD-ROM)), through an application store (e.g., Play Store™), directly between two user devices (e.g., smart phones), or online (e.g., downloaded or uploaded). In the case of online distribution, at least part of the computer program product (e.g., a downloadable app) may be at least temporarily stored or arbitrarily created in a storage medium that may be readable to a device such as a server of the manufacturer, a server of the application store, or a relay server.

Although the embodiments of the disclosure have been described with reference to the accompanying drawings, those skilled in the art will appreciate that these inventive concepts may be embodied in different forms without departing from the scope and spirit of the disclosure, and should not be construed as limited to the embodiments set forth herein.

What is claimed is:

1. A refrigerator, comprising:
an aging chamber configured to store an object to be aged;
a cooling portion configured to reduce a temperature in the aging chamber;
a heating portion configured to increase the temperature in the aging chamber;
a controller configured to control an aging temperature of the aging chamber by controlling at least one of the cooling portion and the heating portion to allow an aging process to be performed on the stored object for a preset aging time; and
a storage configured to store user feedback information on at least one of an aging degree of the object for which the aging process is completed and food manufactured using the object,
wherein the controller is configured to control at least one of the aging temperature and the aging time based on the user feedback.

2. The refrigerator of claim 1, further comprising:
a scan portion configured to, based on a packaged product being stored in the aging chamber, scan at least one of a product name, a manufacturing date, a capacity, and a barcode of the packaged product.

3. The refrigerator of claim 1, further comprising:
a user interface including a display, the user interface configured to, based on the object being stored in the aging chamber, display a menu on the display to allow a selection of at least one of a type, a manufacturing date, a target aging degree, a purpose of aging, and a capacity of the object.

4. The refrigerator of claim 1, further comprising:
a sensor configured to measure an aging degree of kimchi, based on the kimchi being stored in the aging chamber,
wherein the storage is further configured to store at least one of an aging state, a type, and a capacity of the kimchi, the aging state being measured by the sensor before the aging process is performed,
wherein the controller is further configured to set at least one of an aging temperature and an aging time to reach a preset target aging degree of the kimchi based on the at least one of the aging state, the type, and the capacity of the kimchi.

5. The refrigerator of claim 4, wherein the controller is configured to:
measure the aging degree of the kimchi by the sensor at a preset interval during the aging process of the kimchi stored in the aging chamber;
determine whether the target aging degree is reachable within the aging time based on the measured aging degree of the kimchi; and
adjust the aging temperature of the kimchi to reach the target aging degree within the aging time based on a result of determination.

6. The refrigerator of claim 5, wherein the controller is further configured to:
transmit, to a user terminal, a message inquiring about whether to adjust the aging temperature of the kimchi based on the result of determination; and
adjust the aging temperature of the kimchi based on a response to the message received from the user terminal.

7. The refrigerator of claim 4, wherein the controller is further configured to operate the aging chamber in a storage mode at a set temperature, in response to the aging state of the kimchi exceeding the target aging degree of the kimchi.

8. The refrigerator of claim 4, wherein the sensor is configured to measure a pH value indicating the aging degree of the kimchi.

9. The refrigerator of claim 1, further comprising:
a sensor configured to measure an aging degree of dough, based on the dough being stored in the aging chamber,
wherein the controller is further configured to set at least one of an aging temperature and an aging time to reach a preset target aging degree of the dough based on at least one of an aging state, a type, and a capacity of the dough, the aging state being measured by the sensor before the aging process is performed.

10. The refrigerator of claim 9, wherein the sensor comprises a camera configured to detect a size of the dough to measure the aging degree of the dough, and
the controller is further configured to:
measure a size of the dough by the sensor at a preset interval during the aging process of the dough stored in the aging chamber;
determine whether the target aging degree is reachable within the aging time based on the measured size of the dough; and
adjust the aging temperature of the dough to reach the target aging degree within the aging time based on a result of determination.

11. The refrigerator of claim 1, wherein the heating portion comprises:
a heater case configured to support a lower part of the aging chamber; and
a heater accommodated in the heater case, and
wherein the heater case includes a lower frame and an upper frame coupled to an upper part of the lower frame,
the heater is attached to an inner top surface of the upper frame, and
the lower frame includes a protrusion configured to support the heater to allow the heater to be in close contact with the upper frame.

12. The refrigerator of claim 1, further comprising:
a user interface including a display,
wherein the user feedback information is to be received through the user interface and stored in the storage.

13. A method for aging food in a refrigerator having an aging chamber, a controller configured to control an aging temperature in the aging chamber and a storage, comprising:
performing, by the refrigerator, an aging process on an object stored in the aging chamber based on an aging temperature and an aging time;
receiving, by the controller, user feedback information on at least one of an aging degree of the object for which the aging process is completed and food manufactured using the object; and
controlling, by the controller, at least one of the aging temperature and the aging time based on the received user feedback information.

14. The method of claim 13, further comprising:
transmitting an aging completion message to a user terminal, based on a completion of the aging process.

15. The method of claim 13, further comprising:
measuring an aging state of the object stored in the aging chamber before the aging process is performed; and
setting at least one of the aging temperature and the aging time to reach a target aging degree of the object based on at least one of the aging state, a type, and a capacity of the object.

16. The method of claim 15, further comprising:
operating the aging chamber in a storage mode at a set temperature, in response to the measured aging state of the object exceeding the target aging degree of the object.
